(19) United States
(12) Patent Application Publication
(10) Pub. No.: US 2016/0275809 A1
(43) Pub. Date: Sep. 22, 2016

(54) MOTION PLATFORM SYSTEM

(71) Applicant: ELECTRONICS AND TELECOMMUNICATIONS RESEARCH INSTITUTE, Daejeon (KR)

(72) Inventors: Hyun-Woo CHO, Sejong (KR); Hong-Kee KIM, Daejeon (KR); Woo-Jin JEON, Jeonju-si (KR); Ki-Hong KIM, Sejong (KR)

(21) Appl. No.: 15/070,393

(22) Filed: Mar. 15, 2016

(30) Foreign Application Priority Data
Mar. 20, 2015 (KR) 10-2015-0039214

(51) Int. Cl. G09B 9/08; G02B 27/01; G09B 9/30; G06T 19/00; G09B 9/20; G09B 9/24; G06F 3/01; G06F 3/16

(52) U.S. Cl. CPC G09B 9/085; G06F 3/012; G02B 27/017; G06F 3/011; G06F 3/16; G06T 19/006; G09B 9/206; G09B 9/24; G09B 9/302; G09B 9/307; G09B 9/301

(57) ABSTRACT

A motion platform system includes: a wide-viewing-angle display configured to provide images according to user's head movement; a paragliding harness; a control hand brake; a top frame configured to fix the paragliding harness; a lamp structure configured to support the top frame; and a computing device configured to produce contents for the images.

### CROSS REFERENCE TO RELATED APPLICATION

This application claims the benefit under 35 USC 119(a) of Korean Patent Application No. 10-2015-0039214 filed on Mar. 20, 2015 in the Korean Intellectual Property Office, the entire disclosure of which is incorporated herein by reference for all purposes.

### BACKGROUND

1. Field

The following description relates to a motion platform system.

2. Description of Related Art

There are 3 types of existing motion platforms, a small low-cost motion platform, for example, such as a 4D theater or a 4D experience center, an extra-large high-precision motion platform, for example, such as an airplane piloting simulator, and a motion platform for training which can simulate equipment in public or industrial fields, for example, such as a fire truck, a crane or the like.

All these motion platforms provide motions interacting with visual contents to users. Precision, operating range, durability, price and the like of the motion platform are quite different depending on applications. Most of motion platforms are implemented on the assumption that a user sits and feet touch the ground to operate a system. For example, an airplane piloting simulator is designed based on that a user sits down on an airplane cockpit. Thus, there is no need to show all 360° of images for users. Most of cases, showing the front direction from where a user sits by is enough. A 3-axis to 6-axis motion base is located under the feet in an existing motion platform. Even though images can be seen under the feet, most of images are blocked since motions are generated when the motion platform is controlled. A display providing images in an existing motion platform is located in front of the direction where a user sits in the motion platform. A motion platform usually has a display in which multiple flat panel displays are attached like tiles or a curved display in a large cylindrical shape. Images provided through these displays are not affected by any changes of user's position, user's eyes or movement of the motion platform. Because users easily distinguish virtual world, which contents represent, from real world, which devices such as a motion platform show, regardless of size of a display, satisfaction such as feeling of flying in the air is low. Existing virtual reality based-motion platforms cannot effectively provide feeling of being in the air.

TABLE 1

| | Flight | Special equipment for | |
|---|---|---|---|
| Applications | simulator | training | 4D Ride |
| Key features | Extra-large, | Large, Environmental | Small, Low cost |
| | High cost | factors, Precision | |
| Essential | Precision | Environmental factors | Cost, Space |
| points | | | efficiency |
| Applied fields | Military | Special | Theater, Experience |
| | | industries | center |
| | | (Publics) | |
| Provider | Defense | Monopolistic industries | Various industries |
| | industries | | |

Applications of conventional virtual reality based-motion platforms are shown in Table 1. Applications can be divided into a military field, a special industry field (including public), and an entertainment field. Each field provides motions to compensate low satisfaction of contents which are provided with only images since real equipment are very costly and/or quantity is limited. The motion platform can be also applied in extreme sports fields of which interest is increasing.

For example, paragliding is not a sports for beginners to easily experience. It is more important to have actual experiences rather than indirect experiences, for example, such as watching how an expert does. Paragliding-related technologies have been developed mainly for paragliding equipment and aerodynamics, more particularly, equipment which can deal with dangerous situations and/or structural designs of paragliders. These are mostly for experts not for beginners. Some of introductory training equipment for paragliding are existing. However, they are for wearing equipment for paragliding. More advance equipment provide only feeling of the gravity and centrifugal force using a crane.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Disclosed is a motion platform system which can provide 360° images according to user's positions and directions by using interaction between motion platform including a sensor and a wide-viewing-angle display.

In one general aspect, a motion platform system includes a wide-viewing-angle display configured to provide images according to user's head movement; a paragliding harness; a control hand brake; a top frame configured to fix the paragliding harness; a lamp structure configured to support the top frame; and a computing device configured to produce contents for the images.

The wide-viewing-angle display may include a head tracking module and is in a goggles shape to be in contact with the eyes of a user and configured to track user's head movement.

The motion platform system may further include a helmet equipped with the wide-viewing-angle display.

The top frame may be coupled to the lamp structure to move freely according to user's weight movement.

The top frame may include a ball-shaped joint configured to couple the top frame to the upper end of the lamp structure.

The top frame may include a brake sensor module configured to detect pulled degree of the control hand brake and a posture tracking module configured to detect tilted degree of the top frame.

The motion platform system may further include a depth camera disposed in the front of user and configured to capture user's motion, wherein the wide-viewing-angle display outputs virtual reality contents including the captured motion.

The motion platform system may further include a stereo sound providing device disposed on the top frame and configured to output wind sounds to provide realistic experience.

The motion platform system may further include a wind effect providing device disposed on the top frame and configured to generate wind using one or more fans to provide realistic experience.

The motion platform system may further include the stereo sound providing device configured to output wind sounds to compensate noise caused by the fan at the lower end of the lamp structure which is under user's feet.

In another general aspect, a motion platform system includes a wide-viewing-angle display configured to provide images according to user's head movement; a paragliding harness; a control hand brake; a top frame configured to fix the paragliding harness; a lamp structure configured to support the top frame and comprising a motor module configured to provide active motion through the top frame; an operating device configured to control operation of the motor module; and a computing device configured to produce contents for the images and control the operating device.

The motor module may provide motions with a plurality of DOF to produce paragliding motions turning direction to right-to-left.

The motion produced by the motor module may be motion according to air flow or the direction turning motion by user's control.

The contents may be augmented reality images on which flight path information for beginners is superimposed, or augmented reality images on which information of upward and downward air flows except flight path for intermediated level is superimposed.

The motion platform system according to an example can provide 360° images according to user's positions and directions by using interaction between motion platform including a sensor and a wide-viewing-angle display so that users can feel real feeling of being in the air.

Other features and aspects will be apparent from the following detailed description, the drawings, and the claims.

### BRIEF DESCRIPTION OF THE DRAWINGS

FIG. 1 is a diagram illustrating an example of a virtual reality based motion platform system.

FIG. 2 is a diagram illustrating an example of a motion platform system.

FIG. 3 is a diagram illustrating an example of 360° visualized image by a motion platform system.

FIG. 4 is a diagram illustrating an example of a wide-viewing-angle display and a helmet attached with each other.

FIG. 5 is a diagram illustrating an example of a top frame of a motion platform system.

FIG. 6 illustrates an example of image generated using motion tracks.

FIG. 7 is a diagram illustrating an example of installation of a motion capture camera.

FIG. 8 is a diagram illustrating an example of motions according to the direction change.

FIG. 9 is a diagram illustrating an example of a stereo sound providing device.

FIG. 10 is a diagram illustrating an example of a computing device.

FIG. 11 is a diagram illustrating another example of a motion platform system.

FIG. 12 is a diagram illustrating an example of direction changes of paragliding.

FIG. 13 is a diagram illustrating an example of a variable lamp structure.

FIG. 14 is a diagram illustrating an example of motions of a motion platform system.

FIG. 15 is a diagram illustrating an example of guide information using augmented reality.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure is thorough, complete, and conveys the full scope of the disclosure to one of ordinary skill in the art.

The terms used in the description are intended to describe certain embodiments only, and shall by no means restrict the present disclosure. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Hereinafter, certain embodiments of the present disclosure will be described in detail with reference to the accompanying drawings.

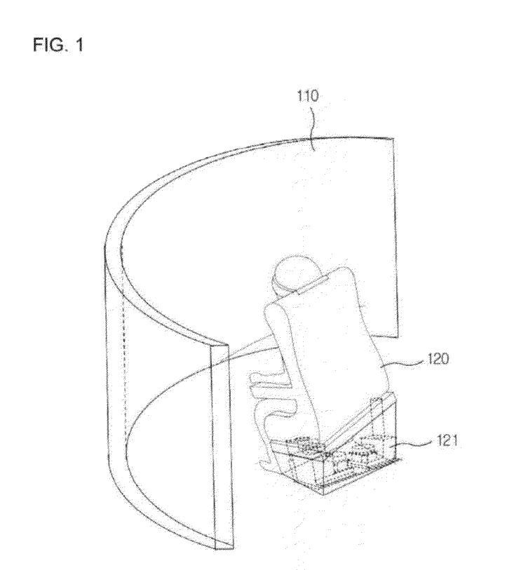

FIG. 1 is a diagram illustrating an example of a virtual reality based motion platform system.

Examples of extreme sports which provides feeling of being in the air include paragliding, hang gliding, parachuting and the like. Other sports such as sky diving, ski jumping and the like also provide feeling of flying in the air but do not require special equipment to float in the air. Thus, when equipment for such sports are built with a motion platform, experience effect is relatively poor because users do not need to control the motion platform but do free fall. Hang gliding provides feeling of being in the air to a user by using wind, and requires user's control so that it is appropriate to be built with a motion platform. However, since a user has to lie down for hang gliding, space efficiency is low. Parachuting provides feeling of being in the air in a seated posture and is thus appropriate to be built with a motion platform. However, it does not require special control, and feeling of being in the air is low after releasing a parachute since feeling at the moment when the parachute is released is very strong. Accordingly, paragliding, which combines hang gliding and parachuting, can be very appropriate to be built with a motion platform. Examples of non-motorized extreme sports which provide feeling of being in the air are compared in Table 2.

TABLE 2

| Sports | Parachuting | Hang gliding | Paragliding |
|---|---|---|---|
| Feeling of | yes | yes | yes |
| being in | | | |
| the air | | | |
| Control | Limited | A lot | A lot |
| Space | Excellent | Relatively inefficient | Excellent |
| efficiency | | | |
| Motions | Moment when a | Sections of flying | Sections of flying |
| | parachute is | down and | down and |
| | released | controlling | controlling |

Flying down with simple equipment but without special power units requires considerable amount of training. A virtual reality based-motion platform system may provide two effects of which one is an experience of paragliding easily and safely on the ground before actual paragliding and the other is enjoying paragliding anytime and anywhere by eliminating limited conditions, for example, such as going back to the top of mountain after trying, heavy rains and/or winds.

The motion platform system which provides such feelings of being in the air needs to be implemented similarly to actual paragliding and provide feeling of being in an actual paraglider to a user.

Referring to FIG. 1, a conventional virtual reality based motion platform system provides images through a large screen 110 and a motion platform 120 moves corresponding to the images.

The conventional virtual reality based motion platform system cannot provide images according to user's eye movement. Since external environments outside the display 110 are exposed together with images, a user cannot feel of being in the images. A device 121 which controls movement of the motion platform 120 is composed of 3-axis to 6-axis motion base near where user's feet are. Because user's feet are on the ground, the conventional motion platform system cannot provide feeling of being in the air.

This description is focused on improving 2 factors from the conventional motion platform system. One is providing 360° virtual reality contents without frames by synchronizing according to user's position and direction using a wearable wide-viewing-angle display. The other is a structure to float user's feet from the ground when the user sits on a motion platform.

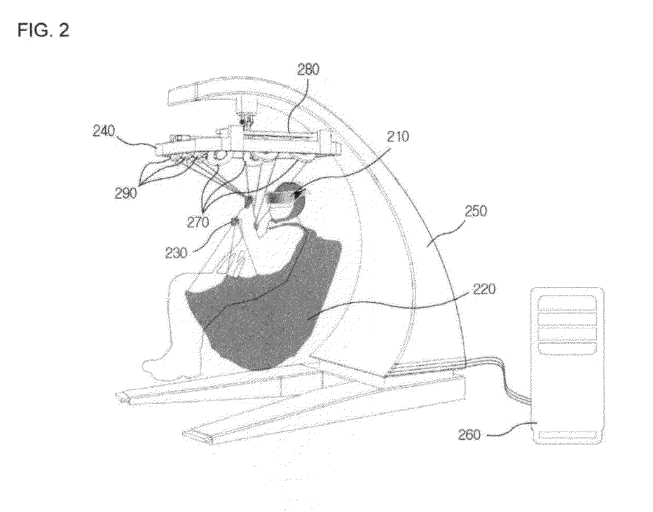

The motion platform system will be described with reference to FIG. 2 to FIG. 15.

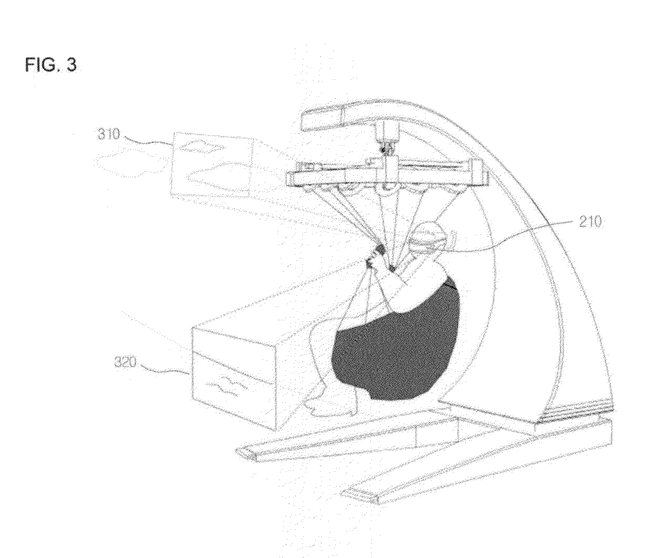

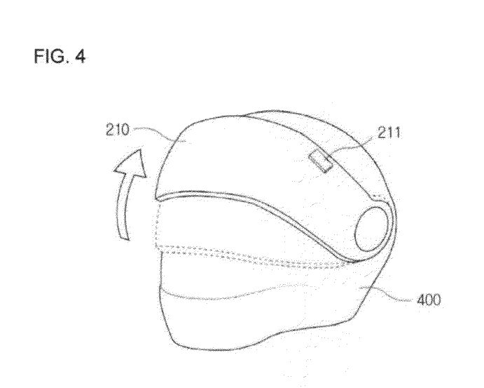

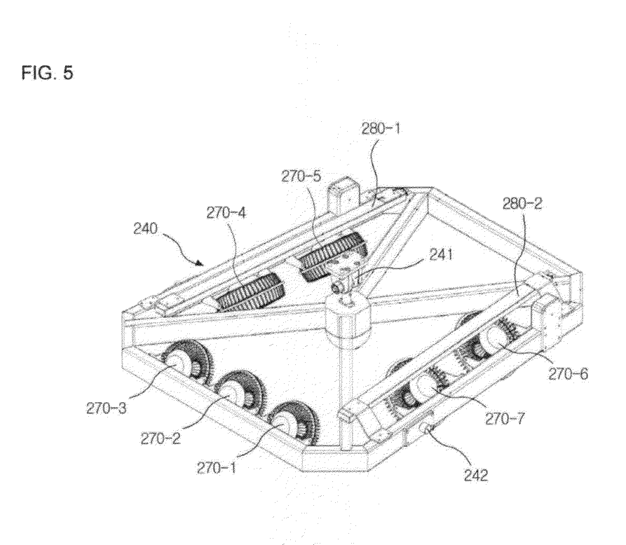

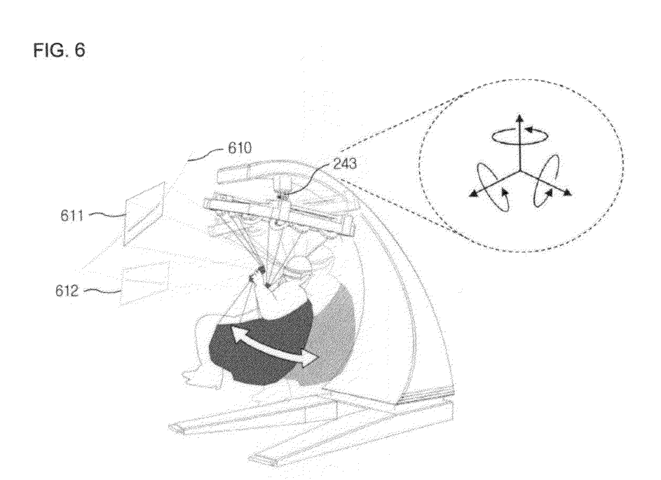

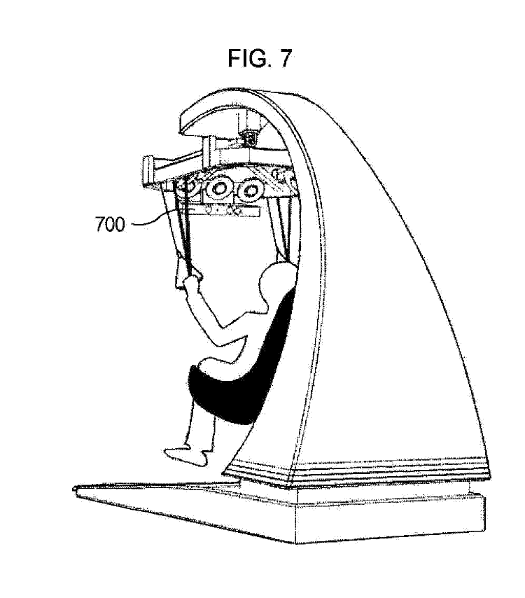

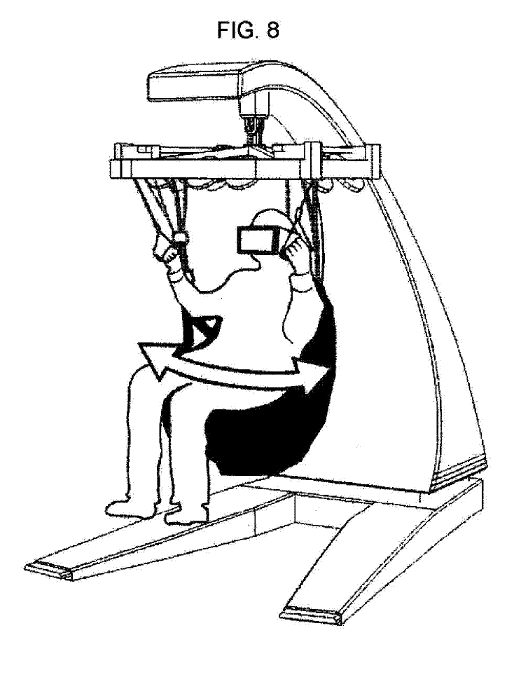

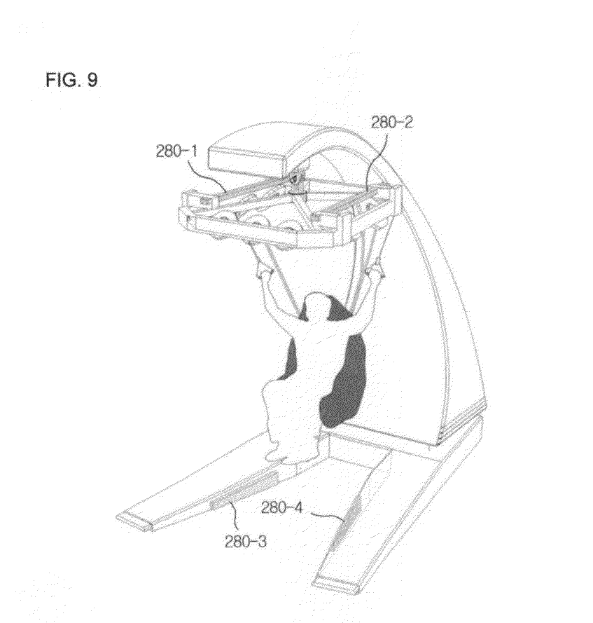

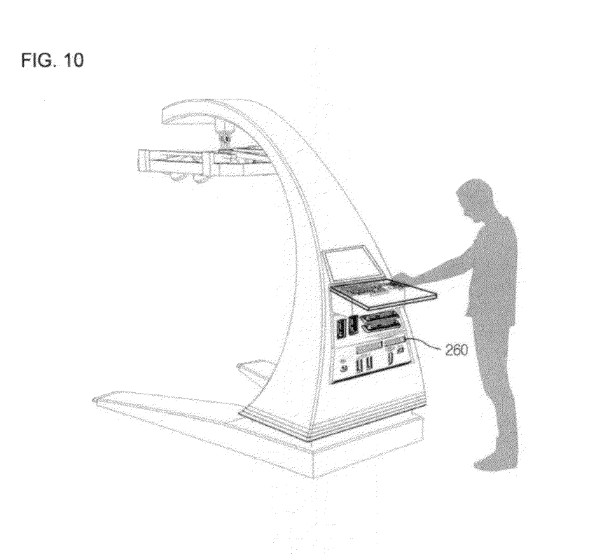

FIG. 2 is a diagram illustrating an example of a motion platform system, FIG. 3 is a diagram illustrating an example of 360° visualized image by a motion platform system, FIG. 4 is a diagram illustrating an example of a wide-viewing-angle display and a helmet attached with each other, FIG. 5 is a diagram illustrating an example of a top frame of a motion platform system, FIG. 6 is a diagram illustrating an example of image generated using motion tracks, FIG. 7 is a diagram illustrating an example of installation of a motion capture camera, FIG. 8 is a diagram illustrating an example of motions according to the direction change, FIG. 9 is a diagram illustrating an example of a stereo sound providing device, and FIG. 10 is a diagram illustrating an example of a computing device.

It is assumed that a motion platform system according to an example simulates paragliding.

Referring to FIG. 2, a motion platform system according to an example may include a wearable wide-viewing-angle display (or a head-mounted display) 210, a paragliding harness 220, a control hand brake 230, a top frame 240, a lamp structure 250 and a computing device 260. The motion platform system may further optionally include a wind effect providing device 270, a stereo sound providing device 280 and a fragrance effect providing device 290.

The wearable wide-viewing-angle display 210 may eliminate drawbacks associated with the conventional motion platform system which exposes external environments outside a display together with images since the display is fixed in the front.

The wearable wide-viewing-angle display 210 may provide images according to user's head movement.

Referring to FIG. 3, when a user with the wearable wide-viewing-angle display 210 sits down and looks at a place other than the front, for example, looks down toward the feet, turns around or looks up right, 360° images, for example, such as a bottom image 320 and an upper right image 310 may be provided through the wearable wide-viewing-angle display 210.

The conventional motion platform system provides images through a fixed display without any special equipment, while the motion platform system according to an example provides inconvenience to wear the display 210. However, since wearing goggles and a helmet is required for paragliding for safety, this inconvenience may not affect to users for paragliding or paragliding training.

As shown in FIG. 4, a paragliding helmet 400 may be equipped with the wide-viewing-angle display 210. The wide-viewing-angle display 210 may include a head tracking module 211 configured to track user's head movement.

Referring back to FIG. 2, an actual paragliding harness 220 and an actual control hand brake 230 may be used. The paragliding harness 220 may be installed in a V form which is the most similar to flying down posture during actual paragliding. The paragliding harness 220 may be thus installed in intermediate posture between lying down posture and seating down posture. This posture may let user's feet in the air not on the ground regardless of user's height and posture when a user sits down on the paragliding harness 220.

The paragliding harness 220 may be fixed on the top frame 240. The top frame 240 may not be fixed but may be freely moved according to user's weight movement.

Referring to FIG. 5, the top frame 240 may include a ball-shaped joint 241 and may be coupled to the upper end of the lamp structure 250 through the joint 241. The joint 241 may be designed and manufactured to support the maximum load or more since it is a coupling unit as the most important unit directly related with safety.

The top frame 240 may include a brake sensor module 242 configured to detect pulled degree of the control hand brake and a posture tracking module 243 configured to detect tilted degree of the top frame 240. These modules may be important sensor units along with the head tracking module 211.

The brake sensor module 242 may need to provide consistent values after pulling and dragging are repeated many times. The brake sensor module 242 may include a potentiometer (e.g., variable resistor). A user may move the center of weight to effectively change direction during paragliding as shown in FIG. 6. The motion platform system has to detect how much and to which a user moves to provide images according to user's position so that the posture tracking module 243 may be needed. The posture tracking module 243 may also need to provide consistent values and sustain real-time characteristics. The posture tracking module 243 may include a gyroscope sensor configured to detect roll, pitch and yaw.

Referring to FIG. 6, as shown in an image 612 when a user sits still and an image 611 when a user tilts the body, even though the user sits and fixes his/her eyes at the horizon 610, when he/she tilts the body, the posture tracking module 243 may detect the tilted degree and generate the image 611 with conversely tilted horizon 610.

360° Omni-directional three-dimensional images, which the wide-viewing-angle display 210 provides, may be implemented in actual aerial photographic images or virtual reality images. When actual world and virtual world are combined, it may be more effective to provide better satisfaction.

For example, since images provided through actual aerial photographing are already taken images, route change by a user is not practically possible. It becomes seeing 360° sceneries of the fixed route by turning his/her eyes away.

It can be used as demonstration materials depending on application fields. For example, it can be used to check major stopovers by watching demonstration images in paragliding. However, images with strong visual effects can increase engagement in experiential and entertainment fields. Here, examples of the term ‘strong visual effects’ may be a bird suddenly passing by in front of his/her eyes, an image very narrowly crossing a bridge or the like. It is very difficult to take photographs of such images due to safety issues. Thus, virtual three-dimensional objects for such images may be made and edited with actual images.

On the other hand, when virtual reality-based contents are used, a user can experience paragliding as he/she controls. Here, when the user looks down or up and looks at hand, leg or canopy, the user can realistically experience. For example, when the user pulls or pushes a handle or a riser or controls a speed bar, actual images of shape and position of hands, riser, and brake string can be edited to show directly to the user. Virtual mages of paragliding, of which canopy is folded or unfolded through user's operation, can be made for training purpose.

When it is not for specialist (professional) training, it is not needed to show actual images but the user may be engaged better with virtual moving hands, feet, and legs moving with movements of hands, feet, and legs.

As shown in FIG. 7, the motion platform system may include a depth camera 700 which may be located in front of a user. The depth camera 700 may capture user's hand and feet motions. The captured motions may be edited into virtual reality contents.

The lamp structure 250 may support the maximum load or more which is enough to support the load of the paragliding harness 220, the top frame 240 and a user. The lamp structure 250 may have enough space (height) so that user's feet do not touch the ground when the user sits in a V shape on the paragliding harness 220. When such conditions are satisfied, the motion platform system may be manufactured in various designs. As shown in FIG. 8, since body is often tilted to the right or the left to change direction in paragliding, the right side and the left side of the lamp structure 250 may be opened not to disturb movements. The top frame 240 and the lamp structure 250 may be manufactured not to hit with each other due to back and forth movements. The motion platform system may further include a brake sensor module 242 which may be mounted on the top frame 240 and a path (not shown) through which data transmission lines of the posture tracking module 243 and power lines pass. When additional equipment such as the wind effect providing device 270, the stereo sound providing device 280 and the fragrance effect providing device 290 are installed, these data transmission lines and power lines may also pass through the path.

The stereo sound providing device 280 may be also needed for realistic experience. Particularly, when wind sounds through the stereo sound providing device 280 is provided with winds through the wind effect providing device 270, reality effect may be doubled.

Referring to FIG. 5, since noise from fans (270-1 through 270-7) of the wind effect providing device 270 is entirely different from the sound heard while flying down against the wind, a user feels as mechanical sounds. Thus, wind sound which can compensate the noise may be made from the stereo sound providing device (280-1, 280-2) which is installed on the top. When contents of paragliding over the sea or the liver are used, stereo sound providing device (280-3, 280-4) which is installed at the bottom may output sound of the waves and water.

The computing device 260 may control the motion platform system, particularly generate contents of images and sounds by operating control programs.

For example, the computing device 260 may be connected with image signal connection lines with the wide-viewing-angle display 210, data transmission lines with the brake sensor module 242, data transmission lines with the posture tracking module 243, data transmission lines with a power relay control board of the wind effect providing device 270. The computing device 260 may be connected with additional monitor of an operator.

As shown in FIG. 10, the computing device 260 may be mounted inside the lamp structure 250. This may facilitate operation since lines are hidden. However, it may increase manufacturing cost due to complicated design of the lamp structure 250 and use of uncommon computer.

The motion platform system according to an example may be used as follows. A user may sit on the paragliding harness 220 and wear the wearable wide-viewing-angle display 210 to be completely close to the eyes. An operator may help for the user to hold the control hand brake 230 and check whether data communications with the computing device 260, the brake sensor module 242 and posture tracking module 243 is normal or not. Then, the computing device 260 may generate contents to be displayed on the wearable wide-viewing-angle display 210. The user may pull or un-pull the control hand brake 230 with the right hand, the left hand or both hands. At the same time or separately, the user may change posture, for example, such as crossing his/her legs or tilting the body to change direction by moving body weight. The user may also change direction that the user wants to see by bobbing and weaving so that the computing device 260 may change direction, position, and altitude of visual contents. When the wind effect providing device 270, the stereo sound providing device 280 and the fragrance effect providing device 290 are installed, the motion platform system may provide effects corresponding to those devices. When it is completed, the user may take off the wearable wide-viewing-angle display 210 and get off safely from the paragliding harness 220 with the operator's help.

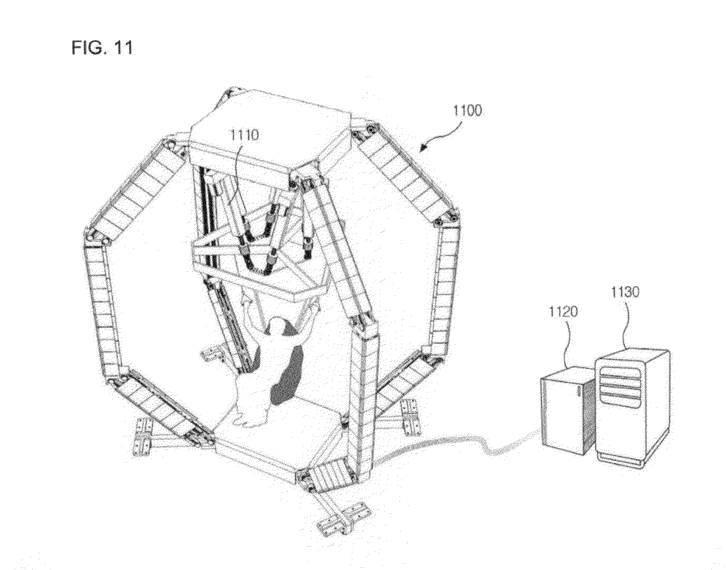

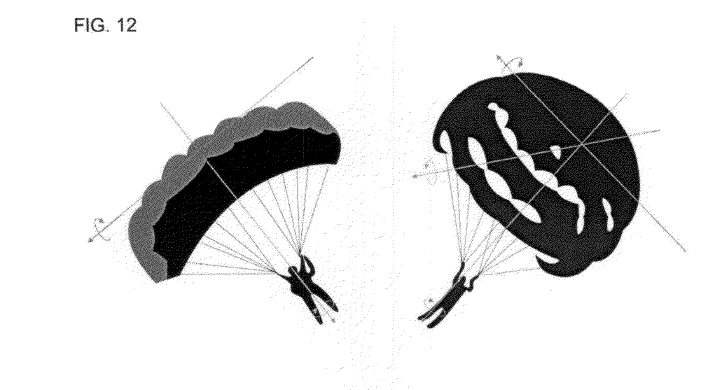

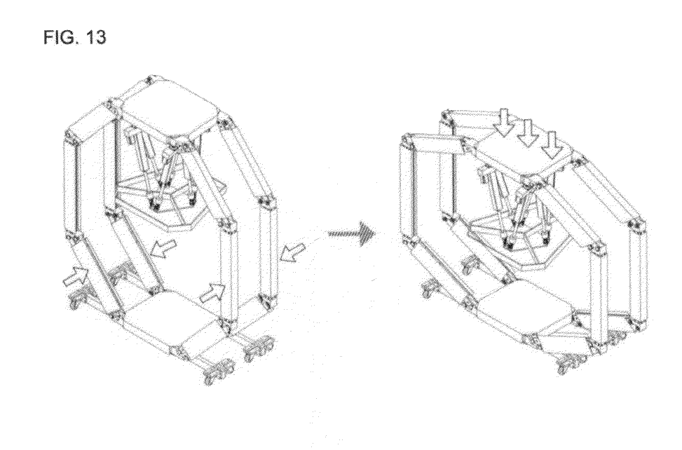

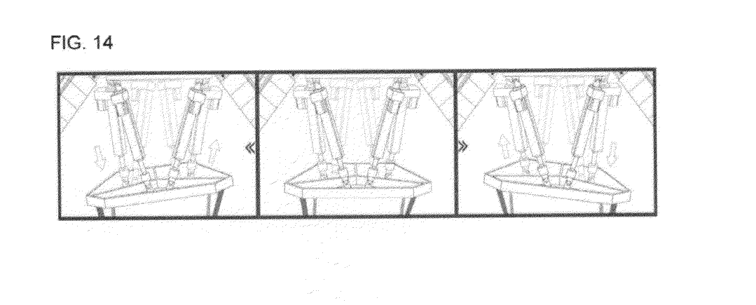

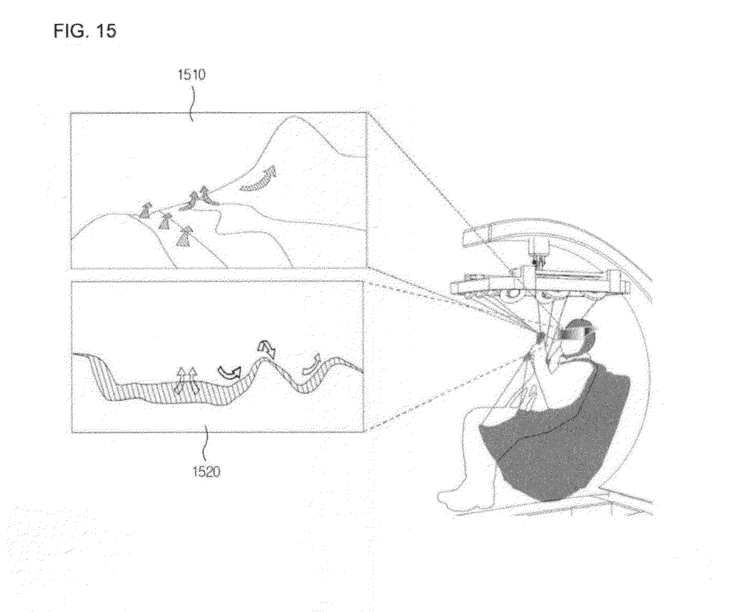

FIG. 11 is a diagram illustrating another example of a motion platform system, FIG. 12 is a diagram illustrating an example of direction changes of paragliding, FIG. 13 is a diagram illustrating an example of a variable lamp structure, FIG. 14 is a diagram illustrating an example of motions of a motion platform system, and FIG. 15 is a diagram illustrating an example of guide information using augmented reality.

A motion platform system according to another example will be described with reference to FIG. 11 to FIG. 15.

The motion platform system in FIG. 2 may be a motion platform effectively experiencing control and feeling of being in the air. It may be built in a small space due to its simple structure. However, since effects of air flow can be very important in case of outdoor sports such as extreme sports, such effects may be made manually. On the other hand, the motion platform system in FIG. 12 may provide changes of angle and position of user's eyes and feeling the force of gravity and inertia which are caused when the user changes direction by drawing curve to the right or the left. Active devices, for example, such as a motor and an actuator may be needed to satisfy such expressions. For example, when a user reaches an upward air flow zone on contents, the motion platform system actually lifts the paragliding harness 220 using a motor to give the user sat on the paragliding harness 220 the ability to feel acceleration as if he/she is rising up. FIG. 11 illustrates a motion platform system in which such considered points are added.

The same configurations in FIG. 11 as those in FIG. 2, for example, such as the wearable wide-viewing-angle display 210, the paragliding harness 220, the control hand brake 230, the top frame 240, the wind effect providing device 270, the stereo sound providing device 280 and the fragrance effect providing device 290 are not shown and description thereof is omitted.

A lamp structure 1100 in the motion platform system in FIG. 11 may include a motor module 1110 on the top thereof to provide active motions in addition to support loads of the motion platform, which is different from that in FIG. 2. Accordingly, the lamp structure 1100 may be formed in an O shape, instead of a C shape, to balance loads. Width and height of the lamp structure 1100 may be adjustable as shown in FIG. 13. For example, wheels may be first loosened to be moved, wheel supports fixed in a radial shape may be placed side by side, and the width may be reduced in a horizontal direction. Height may be lowered by pressing down the top and the motion platform system may be movable in a relatively small volume.

For example, the motor module 1110 may provide 6 DOF (degrees of freedom) motion. As shown in FIG. 12, the motor module 1110 may provide roll, pitch, yaw and heave motions to create paragliding motions switching direction to right-to-left. On the other hand, sway and surge motions may not give large impact. Thus, the motor module 1110 may not be needed to provide 6 DOF motions. The motor module 1110 may provide 6 DOF motions to implement precious motions for training purpose for various air flows, for example, such as turbulence, a gust of wind or the like.

Active motions provided by the motor module 1110 may be used in two different conditions. Active motions may be used in a condition with various environmental factors, for example, such as upward air flow, downward air flow and the like on visual contents to provide rising or falling motions regardless of user's control when the user reaches at a corresponding point. Active motions may be also used in a condition when a user controls the control hand brake 230 to change a flying path to provide corresponding direction changing motion.

When both conditions are used for specialist (professional) training, precision may be critical. It may be very difficult for a beginner to determine whether there is upward air flow or downward air flow ahead during actual paragliding. Such things may be learned through long flying experience based on theories. The motion platform system according to an example may be used for training paragliders with intermediate level or above. Thus, contents may have functions to determine proper air flow information according to location, time, position, direction, range, wind power, wind speed and the like using aerodynamical and climatological, physical simulations in addition to showing three-dimensional geographical features from the sky. Thus, when that point is reached again, the motor module 1110 may operate for a user to recognize gravity and inertial acceleration. As shown in FIG. 15, the motion platform system may provide augmented reality images 1520 superimpostured with flight path information for beginners or augmented reality images 1510 superimpostured with information of upward and downward air flows marked with colors and symbols, except flight path for intermediate levels by using augmented reality for stepwise training and flying skills prior to actual flying.

Visual contents provided with visual information and motions provided through the motor module 1110 may be synchronized in both conditions in FIG. 15. When a mismatched gap between visual contents and motions, for example, such as time difference or difference between visual content and sensory motion is occurred, it may cause problems, for example, such as headache, nausea, sickness or the like. Generally, when motor control runs fast cycle, overall movements controlled by the motor may not be smooth. However, when control instructions are rarely sent to the motor to have smooth movements, precocious motion control may not be provided. Thus, effects provided by the motor module 1110 of the motion platform system in FIG. 11 may be reduced.

The motion platform system in FIG. 11 may further include an operating device 1120 configured to control the motor module 1110. The operating device 1120 may include a real time operating system.

For example, when the real time operating system is installed in the operating device 1120, the following procedure may be used in the former condition of the above-described two conditions.

1) Position or direction of air flow may be predetermined on contents

2) Motion according to each air flow may be recorded in the operating device 1120.

3) When it is arrived a predetermined position, the computing device 1130, which produces virtual reality-based contents, may send an instruction to the operating device 1120 to provide motion according to the position.

4) The operating device 1120 may search the recorded motions and provide the result to the motor module 1110.

5) Smooth movement produced by the real time operating system may be provided to the user sat on the paragliding harness 220 through the top frame 240.

6) The computing device 1130 may read actual motion value from the operating device 1120.

7) The computing device 1130 may change (rise, fall or the like) visual contents according to the motion value read from the operating device 1120.

8) When motion is completed, the operating device 1120 may send a completion signal to the computing device 1130.

The following procedure may be used in the latter condition when motions are needed to be provided according to user's control since directions cannot be predetermined.

1) The control hand brake 230 may be controlled by a user.

2) The computing device 1130 may produce feature values (operating time+operating range) by accumulating sensor values for a certain time.

3) The computing device 1130 may send the produced feature values to the operating device 1120.

4) The operating device 1120 may produce movement based on the feature value to operate the motor module 1110 based thereon.

5) The computing device 1130 may read actual motion values from the operating device 1120.

6) The computing device 1130 may change visual contents (turning direction to right-to-left or the like) based on the motion values read from the operating device 1120.

The procedure from 1) to 6) may be repeated. However, when the feature value is not produced at procedure 2), the procedure from 1) to 2) may be repeated.

When the operating device 1120 is a real time operating system and the computing device 1130 is not a real time operating system, time delay may be caused for data transmission between the computing device 1130 and the operating device 1120 through network. Since direction may be changed a certain time later after a user controls to do (pulls a handle to change direction) in actual paragliding, initial delay till motion is applied after pulling the handle may not significantly affect real feeling. However, when direction change instructions are made consistently from the computing device 1130 after the initial delay, broken motions may be caused. The operating device 1120 and the computing device 1130 may be integrated to apply a real time operating system in order to eliminate this problem. When this method is not feasible due to cost or use of an existing computer, a cycle to extract feature values and instruct them may be controlled to be less frequent cycle. Since precision of motions and smooth motions cause trade off based on this cycle, appropriate values may be produced through experiments by system.

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. A motion platform system comprising:
a wide-viewing-angle display configured to provide images according to user's head movement;
a paragliding harness;
a control hand brake;
a top frame configured to fix the paragliding harness;
a lamp structure configured to support the top frame; and
a computing device configured to produce contents for the images.

2. The motion platform system of claim 1, wherein the wide-viewing-angle display is in a goggles shape to be in contact with the eyes of a user and the wide-viewing-angle display comprises a head tracking module configured to track user's head movement.

3. The motion platform system of claim 2, further comprising a helmet equipped with the wide-viewing-angle display.

4. The motion platform system of claim 1, wherein the top frame is coupled to the lamp structure to move freely according to user's weight movement.

5. The motion platform system of claim 4, wherein the top frame comprises a ball-shaped joint configured to couple the top frame to the upper end of the lamp structure.

6. The motion platform system of claim 1, wherein the top frame comprises:
a brake sensor module configured to detect pulled degree of the control hand brake; and
a posture tracking module configured to detect tilted degree of the top frame.

7. The motion platform system of claim 1, further comprising a depth camera disposed in the front of user and configured to capture user's motion,
wherein the wide-viewing-angle display outputs virtual reality contents including the captured motion.

8. The motion platform system of claim 1, further comprising a stereo sound providing device disposed on the top frame and configured to output wind sounds to provide realistic experience.

9. The motion platform system of claim 8, further comprising a wind effect providing device disposed on the top frame and configured to generate wind using one or more fans to provide realistic experience.

10. The motion platform system of claim 9, further comprising the stereo sound providing device configured to output wind sounds to compensate noise caused by the fan at the lower end of the lamp structure which is under user's feet.

11. A motion platform system comprising:
a wide-viewing-angle display configured to provide images according to user's head movement;
a paragliding harness;
a control hand brake;
a top frame configured to fix the paragliding harness;
a lamp structure configured to support the top frame and comprising a motor module configured to provide active motion through the top frame;
an operating device configured to control operation of the motor module; and
a computing device configured to produce contents for the images and control the operating device.

12. The motion platform system of claim 11, wherein the motor module provides motions with a plurality of DOF to produce paragliding motions turning direction to right-to-left.

13. The motion platform system of claim 12, wherein the motion produced by the motor module is motion according to air flow or the direction turning motion by user's control.

14. The motion platform system of claim 11, wherein the contents is augmented reality images superimpostured with flight path information for beginners or augmented reality images superimpostured with information of upward and downward air flows except flight path for intermediated level.
